(19) United States
(12) Patent Application Publication
(10) Pub. No.: US 2014/0053745 A1
(43) Pub. Date: Feb. 27, 2014

(54) STRAIN CONTROLLED INFEED

(71) Applicants: Douglas Joseph Dawley, Dover, NH (US); David Robert Dawley, Rochester, NH (US)

(72) Inventors: Douglas Joseph Dawley, Dover, NH (US); David Robert Dawley, Rochester, NH (US)

(73) Assignee: Goss International Americas, Inc., Durham, NH (US)

(21) Appl. No.: 13/595,008

(22) Filed: Aug. 27, 2012

(51) Int. Cl. B41F 13/02

(52) U.S. Cl. 101/228; 101/484

(57) ABSTRACT

Method and apparatuses for measuring and regulating the strain of a material web is disclosed. A material web is passed through a first and second non-slip roller pair. The first and second roller pair form a predefined span. In some embodiments, the angular positions of the first and second roller pair are monitored, and the phase angle between the roller pairs is calculated. The phase angle is directly related to the level of strain in the web, and the velocity of the web is controlled to maintain a phase angle which corresponds with the desired strain level. This maintains a constant strain level in the predefined span. In one embodiment, the strain entering a non-slip roll pair is controlled to be zero. The roll pair then introduces a predefined strain to the span entering subsequent processes.

This application relates generally to printing presses. More particularly, this invention relates to a method and apparatus for calculating and regulating the infeed web strain in a printing press.

### BACKGROUND

Some degree of strain or tension control is necessary at the input of any web transport process. Too much or too little strain can result in product damage or the web may break. A typical web press infeed controls the tension of the web at the input of the process by maintaining a simple force balance between web tension and an applied, constant load on an idling roll. The force balance is maintained by adjusting the speed of nip rollers located before the force-loaded roll.

Large tension variations at the infeed are known to result in unacceptable register variations throughout the process. Many attempts have been made to produce very accurate tension control infeeds, and some of these efforts have been successful. However, even if the tension is controlled perfectly at the infeed, variations in the material being transported can still result in unacceptable register throughout the process. For example, the modulus of elasticity of newsprint changes as the moisture content of the newsprint varies. As the modulus of elasticity varies the elongation of the newsprint will vary even if a perfectly constant tension is applied. This elongation of the new print—i.e. strain—can produce unacceptable print registration.

### SUMMARY OF THE INVENTION

Accordingly, it is the object of the invention to measure and control infeed strain to improve print register and quality.

In accordance with this object, a web is passed through a first and second non-slip ‘roller pair. The first and second roller pair form a predefined span. The angular positions of the first and second roller pair are monitored, and the phase difference between the roller pairs is calculated. The phase difference is directly related to the level of strain in the web, and the velocity of the web is controlled to maintain a phase angle which corresponds with the desired strain level. This maintains a constant strain level in the predefined span.

In a further embodiment of the present invention, the strain control infeed includes a load-measuring idler roll located between the first and second roller pairs. The load measured by the idler roller can be used to control the infeed tension.

In yet another embodiment, a first and second non-slipping roller pair define a span of the web. The first roller pair is controllably driven so that there is a slack maintained in the span. The second roller pair is controllably driven to maintain constant infeed strain to the printing press.

Advantageously, in this embodiment, the tension of the web at the entry point to the strain control infeed does not need to be maintained at a level appropriate for the printing process. The tension can be varied according to the needs of the pre-infeed processes. For example, the tension can be varied as necessary for a splicing into a new roll of paper. Therefore, this embodiment eliminates the need for a separate, tension-controlled infeed. Further objectives and advantages of the subject invention will be apparent to those skilled in the art from the detailed description of the disclosed invention.

### BRIEF DESCRIPTION OF DRAWINGS

FIG. 1a shows a first embodiment of an infeed strain control device of the present invention.

FIG. 1b shows an exemplary flow chart for the embodiment of FIG. 1a.

FIG. 1c illustrates the convention that an increased strain will result in a decreased Φab, i.e. that Φab=Φa−Φb, where Φ is clockwise positive.

FIG. 2a shows a second embodiment of an infeed strain control device of the present invention.

FIG. 2b shows an exemplary flow chart for the embodiment of FIG. 2a.

FIG. 3a shows a third embodiment of the present invention.

FIG. 3b shows an exemplary flow chart for the embodiment of FIG. 3a.

FIG. 4 shows illustrates a hardware implementation of the flow chart of FIG. 3b.

### DETAILED DESCRIPTION OF PREFERRED EMBODIMENTS

The subject invention will now be described in detail for specific preferred embodiments of the invention, it being understood that these embodiments are intended only as illustrative examples and the invention is not to be limited thereto.

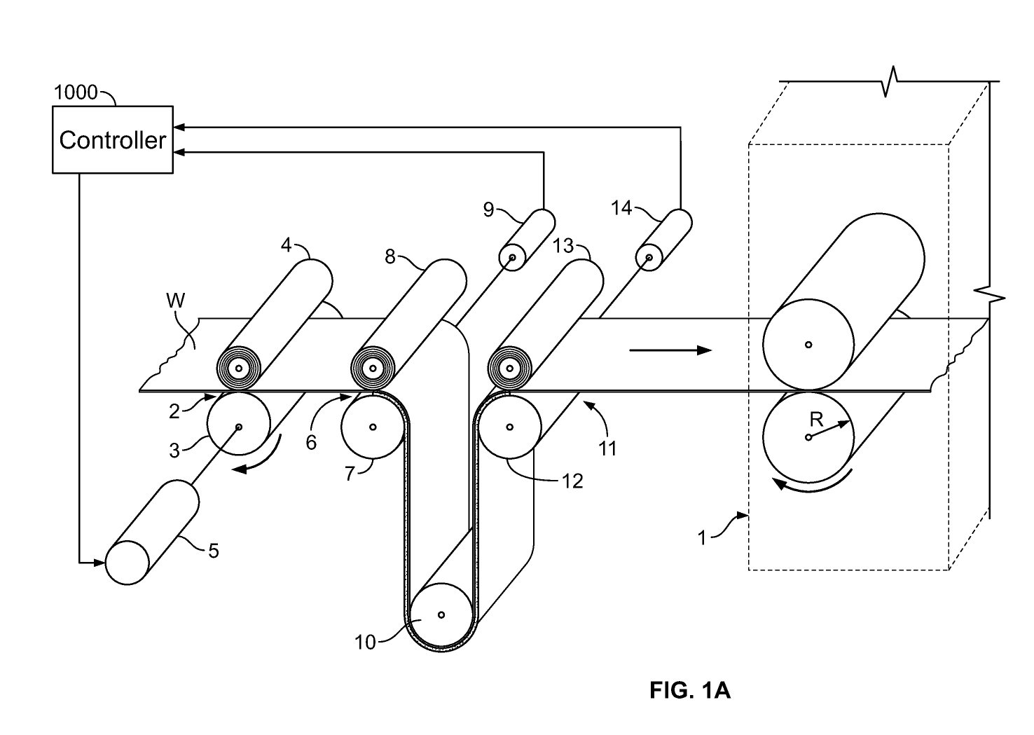

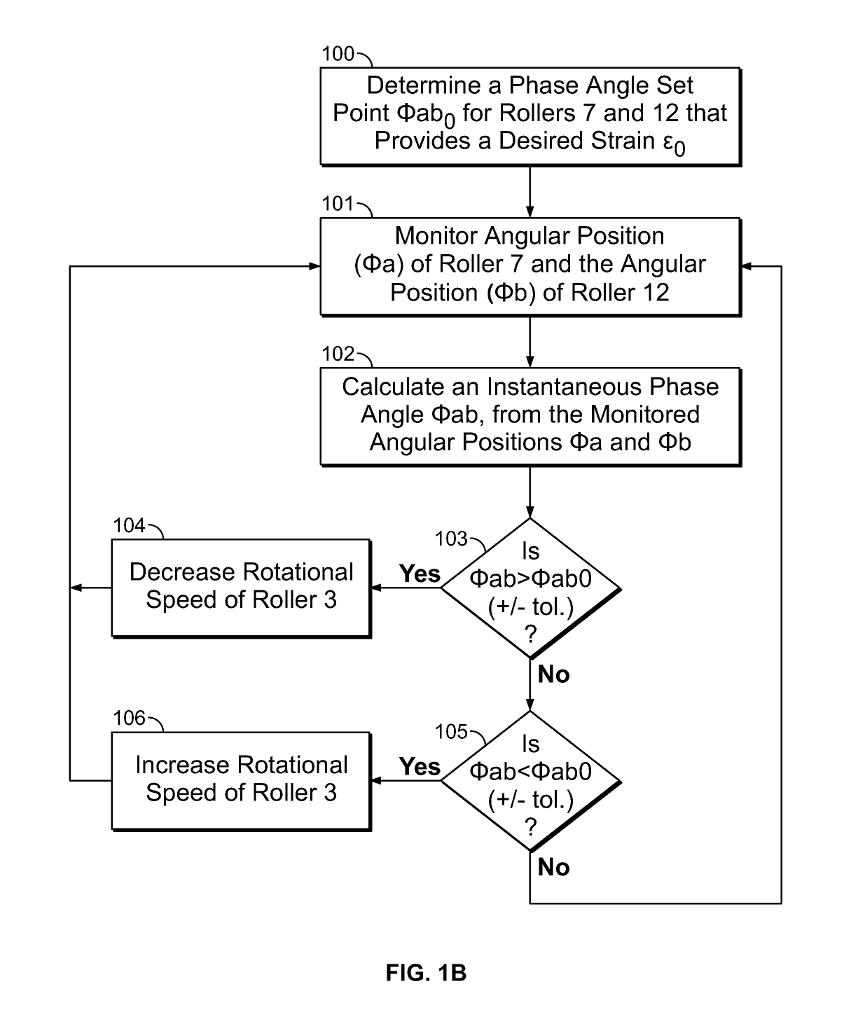

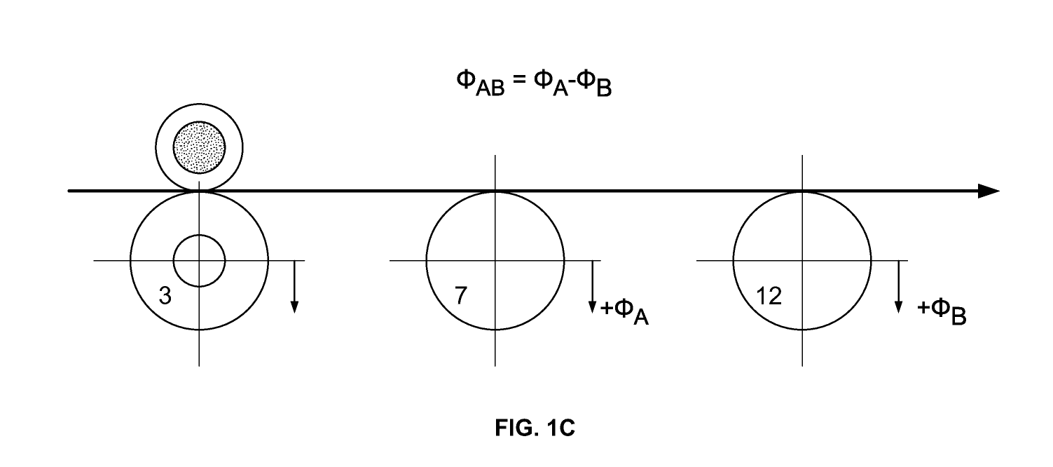

FIG. 1a shows a first embodiment of the strain control infeed. The strain control infeed is disposed between a roll exchanger (not shown) and a printing press 1 (indicated by phantom lines). A pair of cylinders of a printing unit of the printing press 1 are depicted in solid lines to represent the cylinders that comprise the printing nip of the printing unit. As one of ordinary skill in the art will appreciate, in an offset printing press, these cylinders would be blanket cylinders (in a perfecting offset press) or a blanket cylinder and an impression cylinder (in a non-perfecting press). An offset printing press would also include, in each printing unit, a plate cylinder for each blanket cylinder, along with other components such as inking units and dampening units. In a flexographic printing press, the cylinders would be a plate cylinder and an impression cylinder, and each printing unit would also include a flexographic-type inking unit which may, for example include an anilox roller. The web (W) may be, for example a paper web for forming newspapers, magazines, or books, or a cardboard, plastic or metal foil web for forming packaging.

In any event, a material web W is passed from the roll exchanger through a first non-slip roller pair 2. The non-slip roller pair 2 consists of a drive roller 3 in association with a non-slip nip roller 4. The non-slip nip roller 4 ensures that the web is pressed against the drive roller 3. The drive roller 3 is driven by a variable speed drive 5.

The web W is then passed through idling roller pair 6. The idling roller pair 6 comprises an idling roller 7 with an associated non-slip nip roller 8. The nip roller 8 ensures that the web is pressed against the idling roller and assures that there is no slippage between roller 7 and web W. A position feedback device 9—i.e. an encoder—is connected to the idling roller 7 to monitor the angular position Φa of idling roller 7.

In FIG. 1a, the web W is shown passing over an idling roller 10 and through an idling roller pair 11. Roller 10 is not essential to the function of the system, but serves to increase the length of web stored in the span, thereby increasing the amplitude of the signal fed back to the controller. The idling roller pair 11 consists of an idling roller 12 and an associated non-slip nip roller 13 which ensures that the web is pressed against the idling roller, thereby assuring that there is no slippage between roller 12 and web W. A position feedback device 14 is connected to the idling roller 12 to monitor the angular position Φ_{b} of the idling roller. A controller 1000 is coupled to position feedback devices 9 and 14 and to variable speed drive 5. Controller 1000 monitors the angular positions Φa and Φb and calculates a phase angle Φab. The relative position of idling roller 7 and idling roller 12 is fixed. They define a predetermined span with a length L, indicated by shading on the web. For this document, we will adopt the convention that decreasing the strain in the control span will result in an increased Φab. In other words, Φab=Φa−Φb, where Φ is clockwise positive as shown in FIG. 1c.

In operation, the web enters the strain control infeed with a tension T₀. The tension T₀ produces a certain amount of strain ε₀ in the web. The strain ε₀ is a function of the cross-sectional area of the web and the modulus of elasticity of the web. At this strain level ε₀, there is a certain phase angle Φ_{ab0}.

The rotational speed of the variable speed drive 5 is adjusted by the controller 1000 to maintain this desired phase angle Φ_{W} by varying the circumferential velocity of roller 3. The surface velocity of the roller 7, V_{c} (t), is nominally set to be equal to the surface velocity of the web entering the printing unit 1, V_{wu}(t), modified by an amount ΔV_{E}(t), where ΔV_{E}(t) is the surface velocity correction required to maintain a constant phase angle Φ_{ab}. V_{wu}(t), as one of ordinary skill in the art will appreciate, is a function of rotational velocity of the printing unit cylinders, the radius of the printing unit cylinders, and various cylinder properties. When the circumferential velocity of roller 12 is different than the circumferential velocity of the printing cylinder, the web is subjected to a varying strain. For example, if the circumferential velocity of the roller is less than the circumferential velocity of the printing cylinder, an increased strain is produced in the web. This increased strain will alter the phase angle Φ_{ab}. Thus, by monitoring the phase angle and changing the velocity V, (t) to maintain the phase angle at a desired angle, the amount of strain in the web is regulated.

FIG. 1b shows an exemplary flow chart which illustrates the steps that may be performed by controller 1000. Referring to FIG. 1b, at step 100, controller 1000 determines a phase angle set point Φ_{ab0} for rollers 7 and 12 that provides a desired strain ε₀. At steps 101 and 102, the controller 1000 monitors angular position (Φa) of roller 7 and the angular position (Φb) of roller 12, and calculates an instantaneous phase angle Φab, from the monitored angular positions Φa and Φb. For this document, we will adopt the convention that an increased strain will result in a decreased Φab. In other words, as noted previously, Φab=Φa−Φb, where Φ is clockwise positive as shown in FIG. 1c. If the controller determines that Φab>Φab0 (+/−design tolerances) (step 103), the controller 1000 decreases the speed of roller 3 (step 104) and the process returns to step 101. If not, the controller determines if Φab<Φab0 (+/−design tolerances) (step 105), and if it is, the controller 1000 decreases the speed of roller 3 (step 104) and the process returns to step 101. If the result of both 103 and 105 is no, the process returns to step 101 without modifying the speed of roller 3.

As one of ordinary skill in the art will appreciate, controller 1000 can, for example, be a computer, processor, or PLC executing software. Alternatively, it could be implemented entirely in hardware, for example, as an ASIC (“application-specific integrated circuit”), FPLD (“Field-Programmable Logic Device”), analog circuitry, or otherwise implemented in discrete hardware.

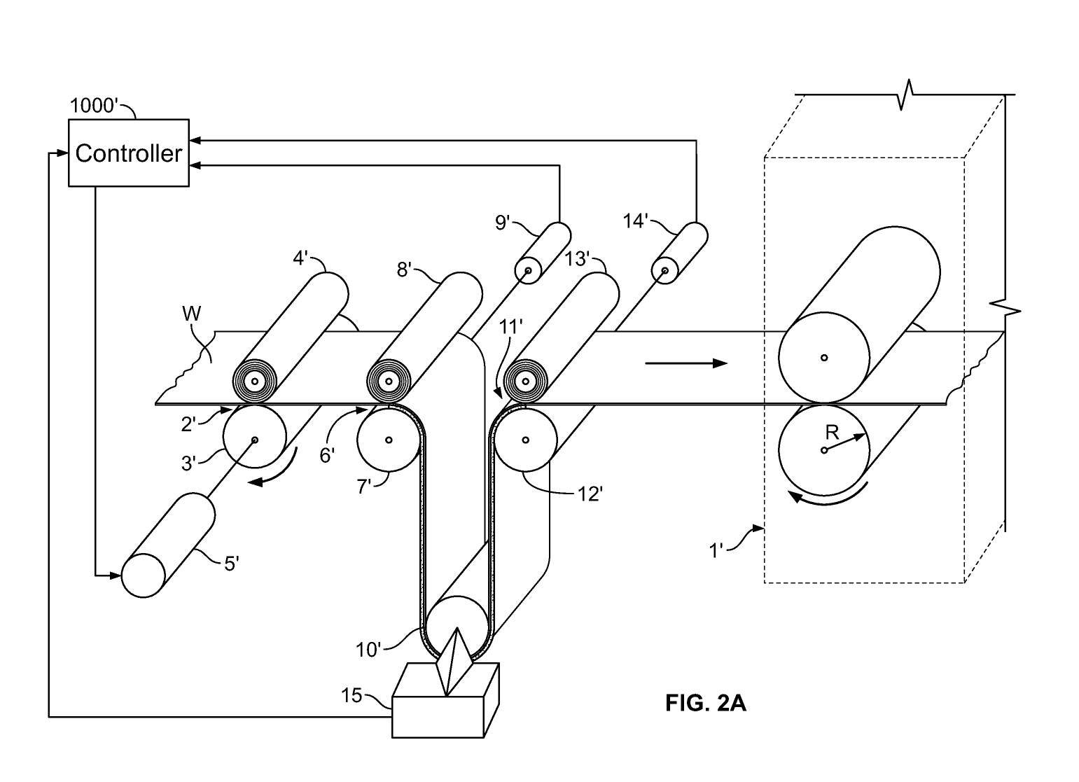

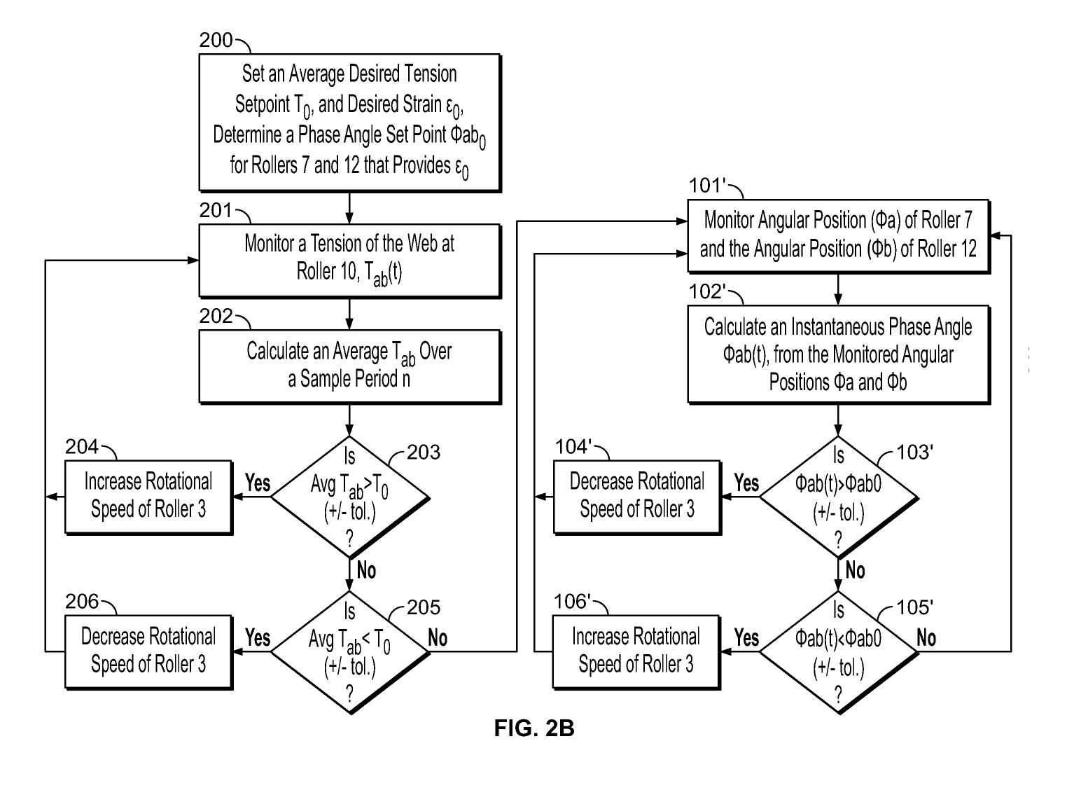

FIG. 2a illustrates a second embodiment of the strain control infeed. This embodiment is similar to the first embodiment. Accordingly, equivalent pieces are indicated by the same reference numerals with a prime. This embodiment includes all the same features as the previous embodiment, and also adds a tension control feature.

A rigid, tension measurement system, 15, is introduced at roll 10′ and is coupled to controller 1000′. The tension measurement system 15 can be any of a number of systems that accurately reports the web tension without introducing a measurable change in path length. One such system would be comprised of a dead-shaft idling roll mounted in calibrated strain-gage transducers at the two side frames. The tension signals from the transducers can be used in either open-loop or closed loop tension control systems. In an open loop system, tension feedback is provided to the operator via the measurement system, 15; the operator adjusts the velocity of roll 3′ until he is satisfied with the span's tension. In a closed loop system, a desired average tension is set at controller 1000′. The average velocity of roll 3′ is adjusted by the controller 1000′ until the tension feedback from the tension measurement system 15 matches the desired average tension set point. After the tension has been brought to the average tension set point, the controller 1000′ switches over to the strain control mode which operates as previously described with regard to FIGS. 1a and 1b. As previously described, the tension of the web will now vary as the strain is controlled by the primary control loop.

If the process requires that the average tension be changed, the strain control mode is disabled. The average circumferential velocity of roll 3′ is adjusted by the control unit as described above until the web tension matches the new average set point. After the average tension has been brought to the new set point, the control unit switches back to the strain control mode.

FIG. 2b shows an exemplary flow chart which illustrates the steps that may be performed by controller 1000′. Referring to FIG. 2b, at step 200, an average desired tension set point T₀ is set by controller 1000′, and controller 1000′ determines a phase angle set point Φ_{ab0} for rollers 7′ and 12′ that provides the desired strain, ε₀. At steps 201 and 202, the controller 1000′ monitors a tension of the web at roller 10′ (T_{ab}(t)), and calculates an average T_{ab} over a sample period n (Avg T_{ab}). If Avg T_{ab}>T₀ (+/−design tolerances), the controller 1000′ increases the rotational speed of roller 3′ and the process returns to step 201. If Avg T_{ab}<T₀ (+/−design tolerances), the controller 1000′ decreases the rotational speed of roller 3′ and the process returns to step 201. If the result of both 203 and 205 is no, then the system has reached the average desired tension, and the process proceeds to step 101′ and strain control mode.

At steps 101′ and 102′, the controller 1000 monitors angular position (Φa) of roller 7′ and the angular position (Φb) of roller 12′, and calculates an instantaneous phase angle Φab, from the monitored angular positions Φa and Φb. If the controller determines that Φab>Φab0 (+/−design tolerances) (step 103′), the controller 1000′ decreases the speed of roller 3′ (step 104) and the process returns to step 101′. If not, the controller determines if Φab<Φab0 (+/−design tolerances) (step 105′), and if it is, the controller 1000′ decreases the speed of roller 3 (step 104′) and the process returns to step 101′. If the result of both 103 and 105 is no, the process returns to step 101′ without modifying the speed of roller 3.

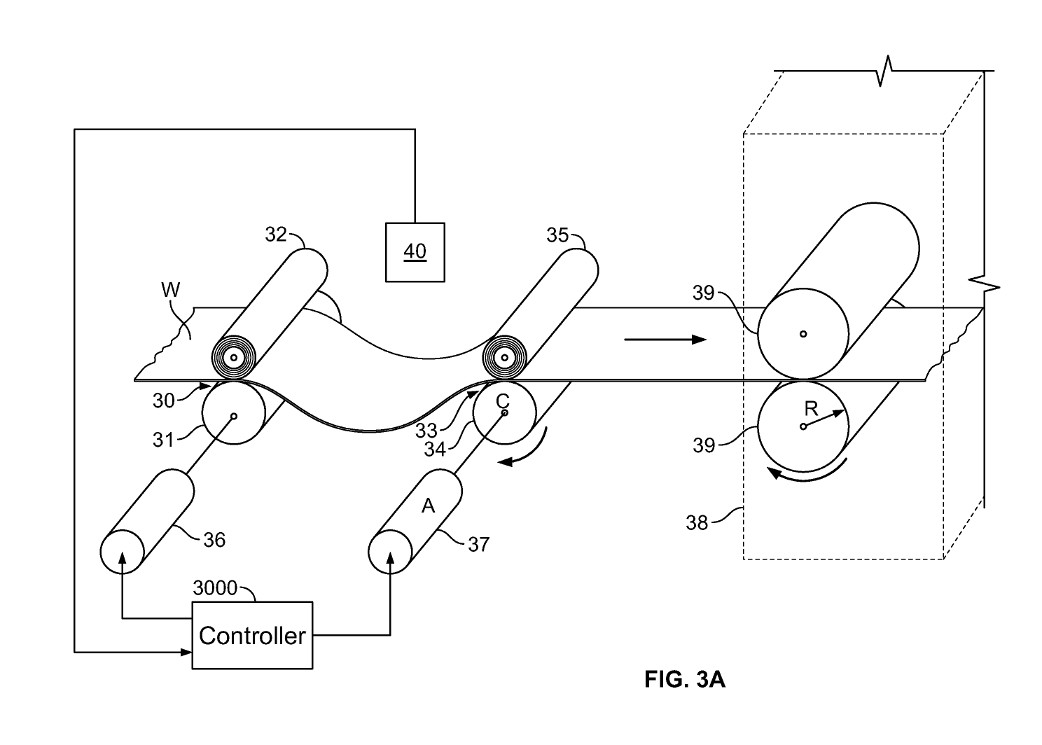

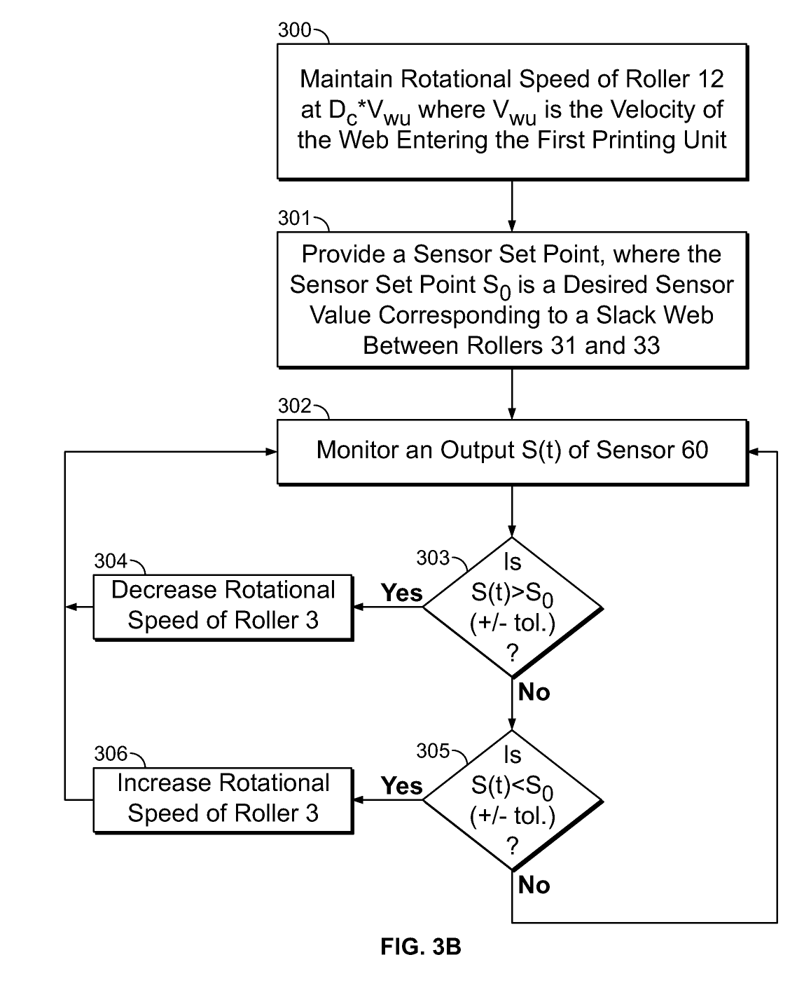

FIG. 3a shows another embodiment of the strain control infeed. A web W is passed from a roll exchanger (not shown) through a non-slip roller pair 30. The non-slip roller pair 30 comprises a roller 31 with an associated non-slip nip roller 32. The web W is then passed through a non-slip roller pair 33. The non-slip roller pair 33 comprises a roller 34 and an associated non-slip nip roller 35. The rollers 31 and 34 are driven by variable speed drives 36 and 37, respectively. The web is then passed into the printing unit 38, (indicated by the phantom lines). A sensor 40 is positioned so that it detects the vertical displacement of the web, W, between roller pairs 31/32 and 34/35. A controller 3000 is coupled to the sensor 40 and variable speed drives 36 and 37.

In operation, the strain of the web is set to 0 as it enters into the roller pair 33. That is a slack span is fed into the roller pair 33. This strain setting of 0 is maintained by varying the speed of roller 31. Sensor 40 provides feedback to the controller 3000, and the controller 3000 varies the speed of drive 36 so that the slack span remains controllable. The sensor 40 can be any device that accurately reports a change in the web's position without introducing strain to the web. One such system would be a non-contacting laser displacement sensor. Another system might be an ultra-sonic sensor that can accurately report displacements of both opaque and transparent substrates. The sensor would provide feedback to the controller 3000 unit, which in turn would control the speed of the drive 36 to maintain a slack span by ensuring that the web is never taut. For example, if the distance from a horizontal, taut web to a sensor located above the web were 1.0″, the control unit might maintain the web's position a distance of 1.5 inches from the sensor to ensure the web is slack.

The strain into the first printing unit 38 is held constant at a preset strain value E₀. This is accomplished by maintaining the circumferential velocity of roller 34 at a fixed percentage of the velocity of the web at the printing cylinders 39. This is done by first calculating the velocity of the web into the printing unit. The velocity is a function of two variables, the radius of the printing cylinder and the rotational speed of the first printing cylinder. The desired rotational velocity is then calculated by multiplying the rotational velocity of the printing cylinder by the desired draw, Dc. Because roller 34 has a known fixed radius, the desired rotational speed of roller 34 can be calculated. The rotational speed is then controlled by the control unit to maintain the desired exit velocity. This then provides a constant strain into the printing unit.

FIG. 3b shows an exemplary flow chart which illustrates the steps that may be performed by controller 3000. The controller 3000 maintains rotational speed of roller 34 at Dc*V_{wu} where V_{wu} is the velocity of the web entering the first printing unit 38 (step 300). A sensor set point (S₀) is provided to the controller 3000 in step 301, where the sensor set point S₀ is a desired sensor value corresponding to a slack web between rollers 31 and 33 (step 301). We will adopt the convention that increasing the length of web in the span (increasing the amount of slack) will increase S(t). The controller then monitors an output S(t) from the sensor 40 (step 302), and if S(t)>S₀, the controller 3000 decreases the rotational speed of roller 31 (steps 303, 304), and if S(t)<S₀, the controller 3000 increases the rotational speed of roller 31 (steps 305, 306).

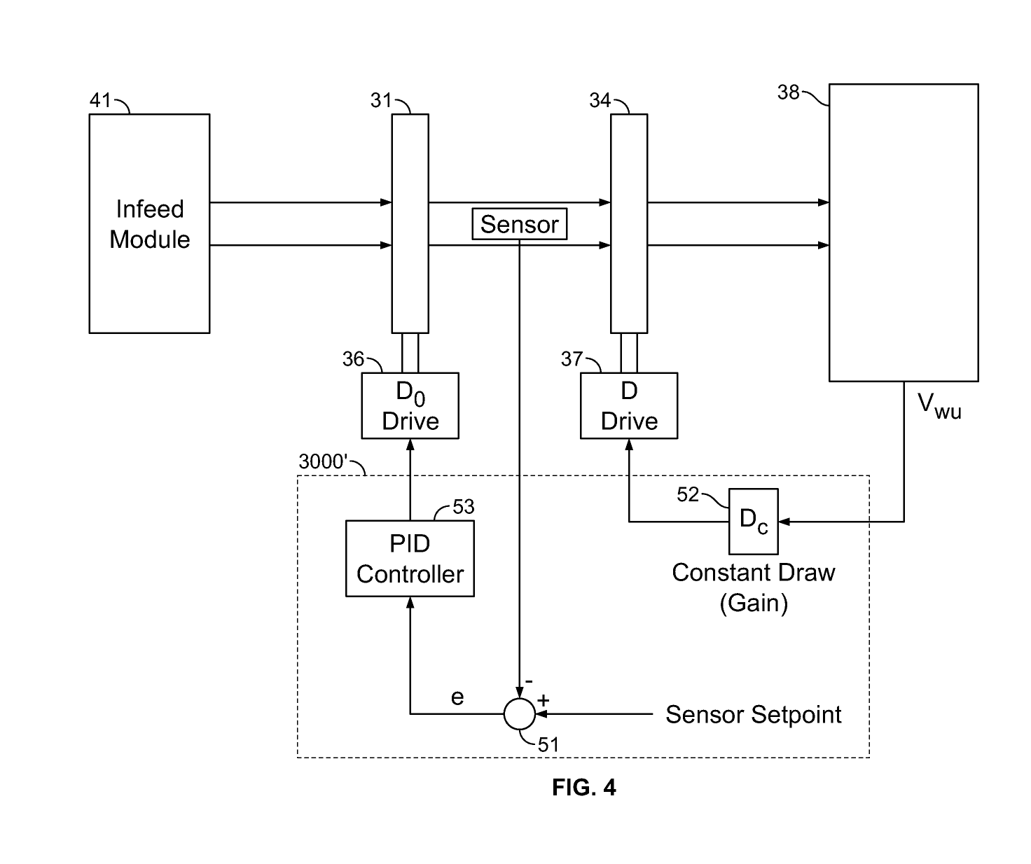

FIG. 4 illustrates an exemplary controller 3000′ which implements the steps of FIG. 3b in hardware. Controller 3000′ includes a constant gain (draw) amplifier 52 to maintain the rotational speed of roller 34 at Dc*V_{wu} and a mixer 51 for generating a velocity change signal e at its output (Sensor set-point minus sensor input), which is input into a PID controller 53 to control the speed of roller 31 via drive 36. The value Vwu can either be generated from a measured value from a sensor on the printing unit cylinder, gear train, or motor, or from the set speed of the press as is well known in the art. The desired draw, Dc, can be determined in a number of ways. For example:
1) It can be defined as a “preset” value that is stored if the current job has been run previously;
2) It can be extracted from a look-up table that lists the recommended draw as a function of substrate; or
3) It can be defined by introducing a system similar to that of embodiment 2. A tension measurement system can be introduced in the span after nip 33. Dc can be defined as the draw necessary to bring the span to a desired running condition.

In the foregoing specification, the invention has been described with reference to specific exemplary embodiments thereof. It will, however, be evident that various modifications and changes may be made without departing from the broader spirit and scope of the invention as set forth in the appended claims. The specification and drawings are accordingly to be regarded in an illustrative rather than a restrictive sense.

What is claimed is:

1. A method for controlling infeed web strain in a printing device, the method comprising:
measuring an operating parameter in a predefined span of the web upstream of the printing device; and maintaining a constant web extension in predefined span by controlling a rotational velocity of a first driven roller of a nip roller pair upstream of the span based on the measured operating parameter so as to maintain a constant web strain in the predefined span.

2. The method as recited in claim 1 wherein the predefined span is defined by a first non-slipping roller pair and a second non-slipping roller pair.

3. The method as recited in claim 2 wherein the first and second non-slipping roller pairs are idling roller pairs and the operating parameter measured is a phase difference between the first and second roller pairs.

4. The method as recited in claim 3 wherein the first driven roller is driven at a nominal rotational velocity modified based on the phase difference between the first and second roller pairs, the nominal rotational velocity being equal to a rotational velocity of a printing cylinder of the printing device.

5. The method as recited in claim 3 wherein the phase difference between the first and second roller pairs is measured using first and second respective feedback devices for sensing the angular positions of a roller in each of the first and second roller pairs.

6. The method as recited in claim 2 wherein the predefined span includes an load measuring idler roller between the first and second roller pairs, the idler roller changing a direction of movement of the web.

7. The method as recited in claim 3 further comprising measuring a tension of the web in the predefined span and maintaining a constant average web tension predefined span by controlling the rotational velocity of the first driven roller based on the measured tension.

8. The method as recited in claim 7 wherein the controlling of the rotational velocity of the first driven roller based on the measured tension is performed by driving the first driven roller a nominal rotational velocity modified based on a desired average tension, the nominal rotational velocity being equal to a rotational velocity of a printing cylinder of the printing device.

9. The method as recited in claim 7 wherein the rotational velocity of the first driven roller is controlled based on the measured tension until a desired average tension of the web is attained, then the rotational velocity of the first driver roller is controlled based on the phase difference between the first and second roller pairs.

10. The method of claim 2, wherein the nip roller pair including the first driven roller is non-slipping.

11. A method for controlling infeed web strain in a printing device, the printing device including a first nip roller pair and a second nip roller pair defining a first web segment of a web therebetween, the second nip roller pair located downstream of the first nip roller pair, the printing device including a first printing unit including a cylinder pair forming a printing nip downstream of the second nip roller pair, the second nip roller pair and the cylinder pair defining a second web segment of the web therebetween, the method comprising:
rotating the second nip roller pair at a first velocity V1(t)=Dc*V_{wu}, where V_{wu} is a speed of the web entering the cylinder pair and Dc is a constant selected to provide a desired strain in the second web segment; rotating the first nip roller pair at a second velocity V2(t), where the second velocity is a velocity selected to maintain a slack condition in the first web segment.

12. The method as recited in claim 11 wherein the slack condition is measured using a sensor.

13. A device for conveying a web in a printing device, the device comprising:
a first non-slipping roller pair and a second non-slipping roller pair defining a span of the web;
a first driven roller of a third roller pair located upstream of the span;
a controller, the controller controlling a rotational speed of the first driven roller based on a measured operating parameter in the span so as to maintain a constant web extension in the span,
a constant web strain thereby being maintained in the span.

14. The device as recited in claim 13 wherein the first and second non-slipping roller pairs are idling roller pairs, the operating parameter being a phase difference between the first and second roller pairs, and further comprising a first and second respective feedback devices associated with the first and second roller pairs for sensing the angular positions of a roller in each of the first and second roller pairs so as to measure the phase difference.

15. The device as recited in claim 13 further comprising an idler roller disposed between the first and second roller pairs, the idler roller changing a direction of movement of the web.

16. The device as recited in claim 14 further comprising a tension-measuring device for a measuring a tension of the web in the span and wherein a constant average web tension is a maintained in the span by the controller controlling the rotational velocity of the first driven roller based on the measured tension.

17. The device as recited in claim 13 wherein the rotational velocity of the first driven roller is controlled based on the measured tension until a desired average tension of the web is attained and then the rotational velocity of the first driven roller is controlled based on the phase difference between the first and second roller pairs.

18. The device as recited in claim 17 wherein the controlling of the rotational velocity of the first driven roller based on the measured tension is performed by driving the first driven roller a nominal rotational velocity modified based on a desired average tension, the nominal rotational velocity being equal to a rotational velocity of a printing cylinder of the printing device.

19. The device of claim 13, wherein the nip roller pair including the first driven roller is non-slipping.

20. A printing device including a first nip roller pair and a second nip roller pair defining a first web segment of a web therebetween, the second nip roller pair located downstream of the first nip roller pair, the printing device including a first printing unit including a cylinder pair forming a printing nip downstream of the second nip roller pair, the second nip roller pair and the cylinder pair defining a second web segment of the web therebetween, the printing device further including a controller for controlling a velocity of the first nip roller pair and the velocity of the second nip roller pair, the controller controlling the printing device to perform the method of claim 15.
